(19) United States
(12) Patent Application Publication
(10) Pub. No.: US 2012/0214554 A1
(43) Pub. Date: Aug. 23, 2012

(54) CONNECTION MEMBER AND ELECTRONIC DEVICE

(75) Inventor: Takayuki Kubodera, Kanagawa (JP)

(73) Assignee: KYOCERA CORPORATION, Kyoto (JP)

(21) Appl. No.: 13/504,650

(22) PCT Filed: Oct. 26, 2010
(86) PCT No.: PCT/JP2010/068894

§ 371 Date: Apr. 27, 2012

(30) Foreign Application Priority Data
Oct. 28, 2009 (JP) 2009-248075

(51) Int. Cl. H04W 88/02

(52) U.S. Cl. 455/566

(57) ABSTRACT

A portable telephone comprises a connection member for connecting a display unit side casing and an operating unit side casing, the connection member being able to be switched between: a closed state in which the display unit side casing is stacked on the operating unit side casing; a first open state in which the display unit side casing is moved a first distance in a first direction parallel to an operating unit side surface from the position in the closed state; and a third state in which the display unit side casing is moved a second distance in the first direction from the position in the first open state and is moved a third distance in a second direction so that the display unit side surface is positioned on substantially the same surface as the operating unit side surface.

### TECHNICAL FIELD

The present invention relates to a connecting member for connecting a first casing and a second casing, and an electronic device including the connecting member.

### BACKGROUND ART

Conventional electronic devices such as a portable telephone include a so-called slide-type portable telephone. A slide-type portable telephone is configured for example to enable sliding of a display unit side casing including the display unit in a predetermined direction relative to an operating unit side casing that includes the operating unit. The slide-type portable telephone includes a closed state in which both casings are stacked when not in use, and an opened state in which both casings are separated by sliding of the display unit side casing in the predetermined direction when in use. The slide-type portable telephone is compact in the closed state when not in use and is extended by a predetermined length into the opened state when in use.

Therefore, a normal slide-type portable telephone is extended by a predetermined length when in an opened state. A step is formed in the portable telephone in the extended opened state at a portion at which the operating unit side casing is stacked onto the display unit side casing. Consequently, a problem associated with a normal slide-type portable telephone is difficulty of operation.

In this context, a portable telephone has been proposed that is provided with a linking hinge to connect and enable relative displacement between the upper casing and the lower casing so that at least one portion of the upper surface of the casings configures a relative position substantially without a step when the upper casing (display unit side casing) and the lower casing (operating unit side casing) are in an opened state (for example, reference is made to Patent Document 1).

### [Patent Document 1] Japanese Unexamined Patent Application Publication (JP-A) No. 2008-271027

### DISCLOSURE OF THE INVENTION

### Problems to be Solved by the Invention

However, when the portable telephone in Patent Document 1 is changed from a closed state to an opened state, the upper casing (display unit side casing) does not slide in a linear configuration, but rather is displaced by lifting up with respect to the thickness direction of the upper casing.

In other words, when the portable telephone in Patent Document 1 is changed from a closed state to an opened state, a user must execute that displacement so that the upper casing is lifted up with respect to the thickness direction.

The present invention has the object of providing a connecting member configured to connect the two casings, and that enables configuration of a state in which the surfaces of the two casings are disposed in substantially the same plane, without requiring a user to lift up one of the casings.

Furthermore, the present invention has the object of providing an electronic device provided with the connecting member.

### Means for Solving the Problems

The present invention relates to an electronic device including a first casing that has a first surface disposing at least one of a display unit or an operating unit, a second casing that has a second surface disposing at least one of a display unit or an operating unit, and a connecting member configured to connect the first casing and the second casing. The connecting member connects the first casing and the second casing to enable a change between a first state in which the first casing is stacked on the second surface of the second casing, the first surface is exposed to the outside in a substantially parallel positional relationship to the second surface, and the whole or a portion of the second surface is covered by the first casing, a second state in which the first casing is displaced by a first distance from a position in the first state in a first direction that is parallel to the second surface, and a third state in which the first casing is displaced by a second distance in the first direction from a position in the second state, and is displaced by a third distance in the second direction that is perpendicular to the second surface so that the first surface is positioned on substantially the same plane as the second surface.

The present invention relates to an electronic device including a first casing that has a first surface disposing at least one of a display unit or an operating unit, a second casing that has a second surface disposing at least one of a display unit or an operating unit, and a connecting member configured to connect the first casing and the second casing. The connecting member includes a guided member that is fixed to an inner portion of the first casing, a first member that is fixed to an inner portion of the second casing, a second member that is disposed on the first casing side on the first member and that includes a guide portion that is formed on the opposite side to the first member and is configured to guide the guided member in a first direction that is a parallel direction to the second surface, a displacement restriction portion that restricts the displacement position of the guided member, and a linking portion that is rotatably connected respectively to the first member and the second member and that connects the first member and the second member. The linking portion connects the first member and the second member in a mutual configuration that can be changed between a state in which the second member is stacked in a second direction that is perpendicular to the first direction with respect to the first member and a state in which the second member is aligned with the first member in the first direction.

The present invention relates a connecting member that includes a guided member that is fixed to an inner portion of the first casing, a first member that is fixed to an inner portion of the second casing, a second member that is disposed on the first casing side on the first member and that includes a guide portion that is formed on the opposite side to the first member and is configured to guide the guided member in a first direction, a displacement restriction portion that restricts the displacement position of the guided member, and a linking portion that is rotatably connected respectively to the first member and the second member and that connects the first member and the second member. The linking portion connects the first member and the second member in a mutual configuration that can be changed between a state in which the second member is stacked in a second direction that is perpendicular to the first direction with respect to the first member and a state in which the second member is aligned with the first member in the first direction.

### Effects of the Invention

According to the present invention, a connecting member that connects the two casings can be provided to thereby enable a configuration in which the surfaces of the two casings are disposed on substantially the same plane without a user lifting up one of the casings.

Furthermore, the present invention provides an electronic device that includes the connecting member.

### BRIEF DESCRIPTION OF THE DRAWINGS

FIG. 1 is a plan figure of a portable telephone 1 in a closed state (first state).

FIG. 2 is a plan figure of the portable telephone 1 in a second opened state (third state).

FIG. 3A is a side view of the portable telephone 1 in the closed state (first state).

FIG. 3B is a side view of the portable telephone 1 in a first opened state (second state).

FIG. 3C is a side view of the portable telephone 1 in the second opened state (third state).

FIG. 4 is a perspective view describing a configuration of the connecting member 4.

FIG. 5 is a side view describing the disposition of each constituent member on the connecting member 4.

FIG. 6A is a plan view describing a configuration of the connecting member 4 in the closed state (first state).

FIG. 6B is a side view describing a configuration of the connecting member 4 in the closed state (first state).

FIG. 7A is a plan view describing a configuration of the connecting member 4 in a state between the closed state (first state) and the first opened state (second state).

FIG. 7B is a side view describing a configuration of the connecting member 4 in a state between the closed state (first state) and the first opened state (second state).

FIG. 8A is a plan view describing a configuration of the connecting member 4 in the first opened state (second state).

FIG. 8B is a side view describing a configuration of the connecting member 4 in the first opened state (second state).

FIG. 9A is a plan view describing a configuration of the connecting member 4 in the second opened state (third state).

FIG. 9B is a side view describing a configuration of the connecting member 4 in the second opened state (third state).

FIG. 10 is a schematic view describing a first inclining surface 101.

### EXPLANATION OF REFERENCE NUMERALS

1 Portable Telephone
2 Operating Unit Side Casing
2a Operating Unit Side Surface
2A Third Portion
2B Fourth Portion
3 Display Unit Side Casing
3a Display Unit Side Surface
3A First Portion
3B Second Portion
4 Connecting Member
10 Operating Unit
11 Operating Key Set
12 Audio Input Unit
21 Display Unit
101 First Inclining Surface
102 Second Inclining Surface
103 Third Inclining Surface
104 Fourth Inclining Surface
105 Fifth Inclining Surface
106 Sixth Inclining Surface
200 First Member
207 Pivot Member
207a Insertion Hole
209 Coil Spring
210 Second Member
213 Guide Portion
217 Pivot Member
217a Insertion Hole
218a First Notch
218b Second Notch
230 Linking Portion
240 Rail Member
243a Groove
245a Regulating Member
245b Regulating Member
247 Resilient Member
247a Hole
300 Biasing Member

### PREFERRED MODE FOR CARRYING OUT THE INVENTION

Descriptions are provided hereinafter with reference to the figures regarding embodiments of the present invention.

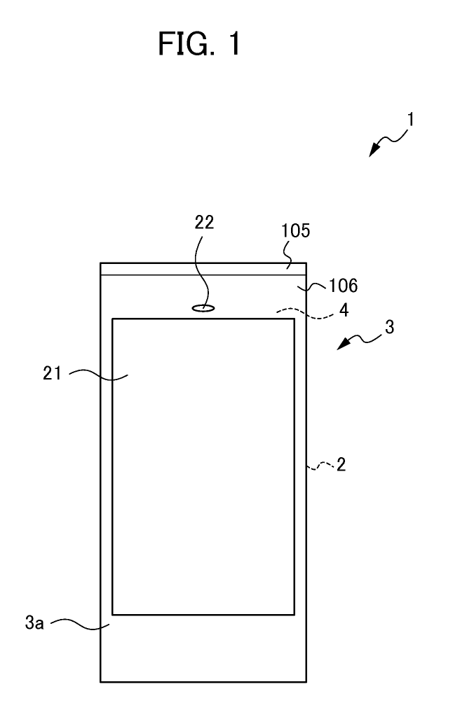

A portable telephone 1 will be described as an example of an electronic device according to the present embodiment with reference to FIG. 1 to FIG. 10.

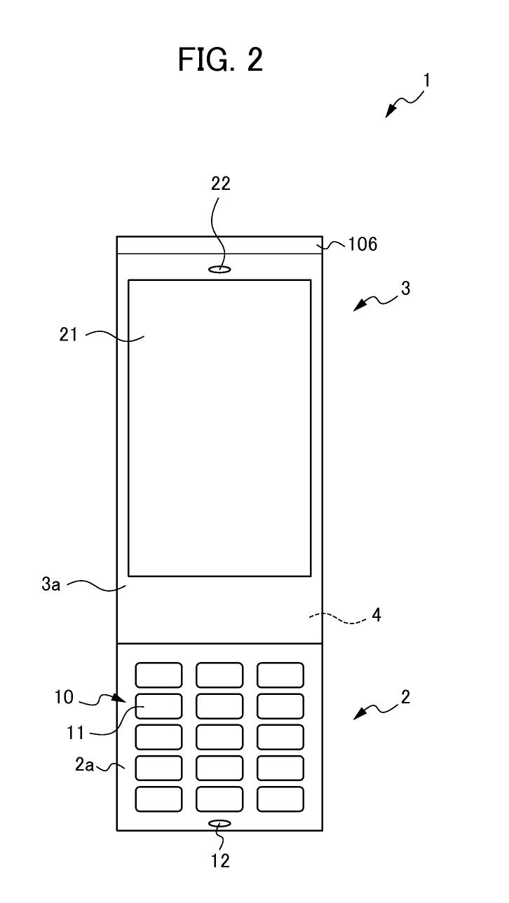

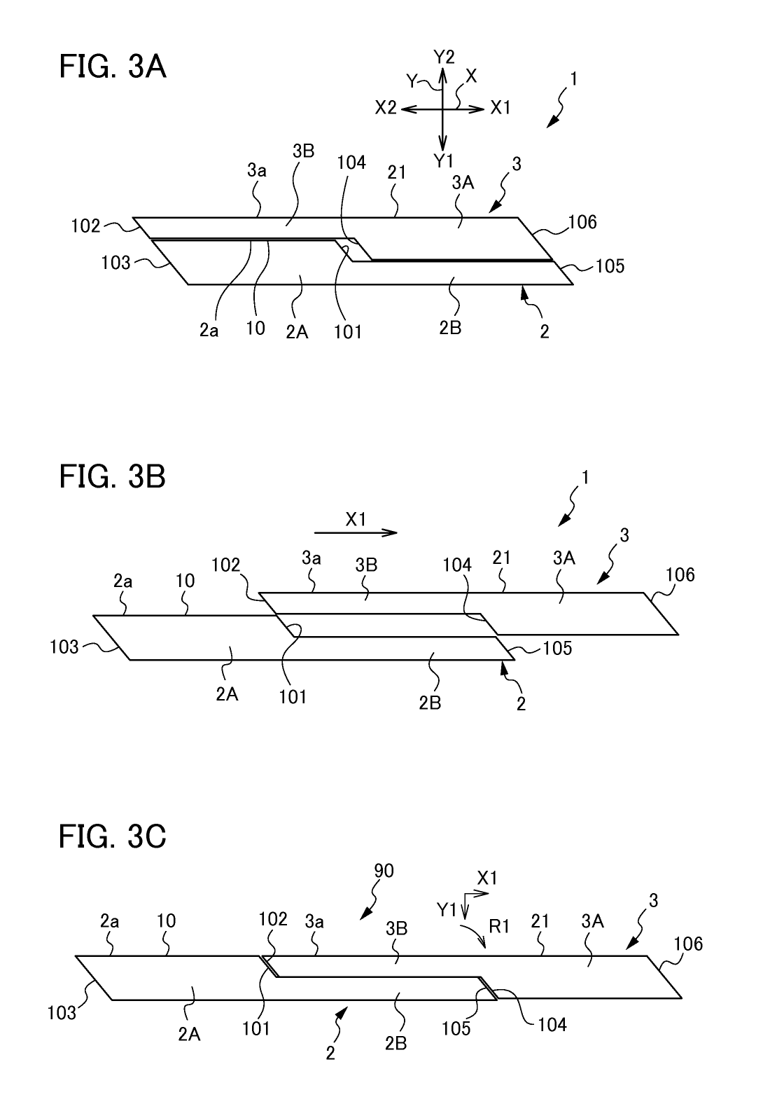

Firstly, the shape of the portable telephone 1 and modified configurations will be described making reference to FIG. 1 to FIG. 3C. FIG. 1 is a plan figure of a portable telephone 1 in a closed state (first state). FIG. 2 is a plan figure of the portable telephone 1 in a second opened state (third state). FIG. 3A is a side view of the portable telephone 1 in the closed state (first state). FIG. 3B is a side view of the portable telephone 1 in a first opened state (second state). FIG. 3C is a side view of the portable telephone 1 in the second opened state (third state).

As illustrated in FIG. 1 to FIG. 3C, the portable telephone 1 is a so-called slide-type portable telephone.

The portable telephone 1 is an example of an electronic device and includes an operating unit side casing 2 as a second casing, a display unit side casing 3 as a first casing, and a connecting member 4 configured to connect the operating unit side casing 2 and the display unit side casing 3.

The portable telephone 1 is configured to enable a change in a state between a closed state (first state) illustrated in FIG. 1 and FIG. 3A, an opened state (second state) illustrated in FIG. 3B, and an opened state (third state) illustrated in FIG. 2 and FIG. 3C. In other words, the operating unit side casing 2 and the display unit side casing 3 are connected by the connecting member 4 that enables a change between the closed state (first state), the first opened state (second state) and the second opened state (third state).

The display unit side casing 3 is stacked to one side surface (operating unit side surface 2a) of the operating unit side casing 2 when the portable telephone 1 is in the closed state. The shape of the portable telephone 1 in the closed state is configured as a parallelogram when viewed from the side.

The display unit side casing 3 is aligned with the operating unit side casing 2 in a first direction X1 when the portable telephone 1 is in the second opened state. The shape of the portable telephone 1 in the second opened state is configured as a parallelogram that is thinner than that when in the closed state when viewed from the side.

When the portable telephone 1 is in the second opened state, in the longitudinal direction (first direction X1, direction X2), the thickness is substantially the same, and the surface of the operating unit side casing 2 and the display unit side casing 3 (the display unit side surface 3a and the operating unit side surface 2a) are disposed on substantially the same plane.

The display unit side casing 3 includes a display unit 21 and an audio output unit 22 disposed on the display unit side surface (first surface) 3a.

The display unit side surface 3a is a surface on which the display unit 21 is disposed on the display unit side casing 3. The display unit side surface 3a is one surface of the display unit side casing 3 and extends on the whole of the display unit side casing 3.

The display unit 21 is exposed on the outside in all of the closed state, the first opened state and the second opened state. The display unit 21 displays a predetermined image.

The audio output portion 22 is formed on one longitudinal end of the display unit side casing 3. The audio output portion 22 is formed on the display unit side surface 3a.

The display unit side casing 3 includes a circuit board and an LCD module including the display unit 21 in an inner portion of the display unit side casing 3.

As illustrated in FIG. 3A to FIG. 3C, the display unit side casing 3 includes a first portion 3A and a second portion 3B that has a lower thickness than the first portion 3A.

The first portion 3A includes a fourth inclining surface 104 and a sixth inclining surface 106.

The fourth inclining surface 104 is formed on the operating unit side casing 2 side and the second portion 3B side of the first portion 3A. The fourth inclining surface 104 is formed on a central portion in a longitudinal direction of the display unit side casing 3 and the operating unit side casing 2 side.

The sixth inclining surface 106 is formed directed to opposite side to the operating unit side casing 2 on an end of the first portion 3A on the opposite side to the second portion 3B. The sixth inclining surface 106 is an inclining surface formed on one end in the longitudinal direction of the display unit side casing 3 (first direction X1, direction X2).

The second portion 3B includes a second inclining surface 102.

The second inclining surface 102 is formed directed to the operating unit side casing 2 on the end of the second portion 3B on the opposite side to the first portion 3A. The second inclining surface 102 is an inclining surface formed on the other end in the longitudinal direction of the display unit side casing 3 on the opposite side to the sixth inclining surface 106.

The operating unit side casing 2 includes an operating unit 10 and an audio input unit 12 disposed on the operating unit side surface (second surface) 2a side.

As used herein, the operating unit side surface 2a is the surface on which the operating unit 10 is disposed on the operating unit side casing 2. The operating unit side surface 2a is one surface of the operating unit side casing 2 and extends onto a portion of the operating unit side casing 2.

The operating unit 10 is covered by the display unit side casing 3 in the closed state and not exposed to the outside, and is not covered by the display unit side casing 3 in the first opened state and the second opened state and is exposed to the outside. The operating unit 10 includes an operation key set 11.

The audio input unit 12 is formed on one end in the longitudinal direction of the operating unit side casing 2. The audio input unit 12 is formed on the operating unit side surface 2a.

Furthermore, the operating unit side casing 2 includes a circuit board, an antenna portion and a battery on an inner portion of the operating unit side casing 2. The circuit board is provided with various types of electronic components including a key structure portion, a key base plate, a case body, and a reference potential pattern layer and cellular telephone RF (radio frequency) module.

As illustrated in FIG. 3A to FIG. 3C, the operating unit side casing 2 includes a third portion 2A, and a fourth portion 2B that has a lower thickness than the third portion 2A.

The third portion 2A is stacked with the second portion 3B of the display unit side casing 3 with respect to the thickness direction (second direction Y1) in the closed state and is not stacked with the display unit side casing 3 with respect to the thickness direction (second direction Y1) in the second opened state.

The fourth portion 2B is stacked with the first portion 3A of the display unit side casing 3 with respect to the thickness direction (second direction Y1) in the closed state and is stacked with second portion 3B of the display unit side casing 3 with respect to the thickness direction (second direction Y1) in the second opened state.

The third portion 2A includes a first inclining surface 101 and a third inclining surface 103.

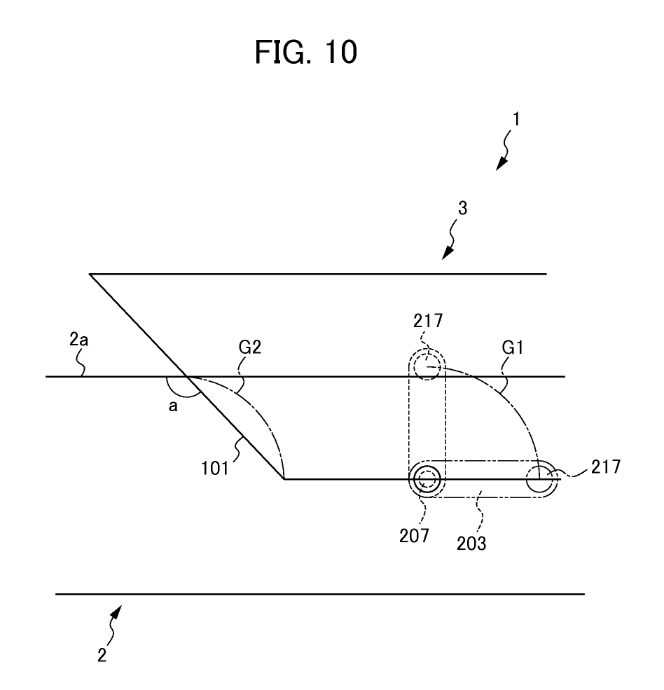

The first inclining surface 101 is formed on the fourth portion 2B side and the display unit side casing 3 side of the third portion 2A. The first inclining surface 101 is formed on a central portion in a longitudinal direction of the operating unit side casing 3 and the display unit side casing 3 side. The first inclining surface 101 is formed so that an angle a subtended by the first inclining surface 101 relative operating unit side surface 2a is 135 degrees (refer to FIG. 10). In the present embodiment, although the angle a is set to 135 degrees, small differences resulting from manufacturing errors or tolerances are allowed (it may be substantially 135 degrees). As described above, the angle a is not limited to 135 degrees, and may be set to any angle that is less than or equal to 135 degrees.

The third inclining surface 103 is formed directed to the opposite side to the display unit side casing 3 on the end of the third portion 2A on the opposite to the fourth portion 2B. The third inclining surface 103 is an inclining surface formed on one end in the longitudinal direction of the display unit side casing 3 (first direction X1, direction X2).

The fourth portion 2B includes a fifth inclining surface 105.

The fifth inclining surface 103 is formed directed to the display unit side casing 3 on the end of the fourth portion 2B on the opposite to the third portion 2A. The fifth inclining surface 105 is an inclining surface formed on one end on the opposite side to the third inclining surface 103 in the longitudinal direction of the operating unit side casing 3 (first direction X1, direction X2).

The second inclining surface 102, the third inclining surface 103, the fourth inclining surface 104, the fifth inclining surface 105 and the sixth inclining surface 106 in the first state and the third state are disposed in parallel to the first inclining surface 101.

The respective inclining surfaces are disposed in parallel in the closed state (first state) and the second opened state (third state).

As described above, the first inclining surface 101 is formed in the present embodiment so that an angle of 135 degrees is subtended with respect to the operating unit side surface 2a.

As illustrated in FIG. 1 and FIG. 3A, the closed state (first state) is the state in which the entire display unit side casing 3 is stacked onto the operating unit side casing 3.

The display unit side casing 3 is stacked on the side with the operating unit side surface 2a of the operating unit side casing 3 when the portable telephone 1 is in the closed state (first state). The display unit side surface 3a is exposed to the outside due to the substantially parallel positional relationship with the operating unit side surface 2a. The operating unit side surface 2a is such that the whole or a portion of the operating unit side surface 2a is covered by the display unit side casing 3.

When the portable telephone 1 is in the closed state, the third inclining surface 103 is substantially parallel to the first inclining surface 101, and disposed on substantially the same plane as the second inclining surface 102.

When the portable telephone 1 is in the closed state, the sixth inclining surface 106 is substantially parallel to the first inclining surface 101, and disposed on substantially the same plane as the fifth inclining surface 105.

That is to say, when the portable telephone 1 is in the closed state, both longitudinal ends of the portable telephone 1 are formed in a respectively inclining flat shape when viewed from the side, and are mutually parallel.

As illustrated in FIG. 3B, the first opened state (second state) is the state in which the display unit side casing 3 is moved by a first distance from the position in the closed state (first state) in a first direction X1 which is parallel to the operating unit side surface 2a. In other words, in the first opened state, the display unit side casing 3 is displaced by a second distance from the position in the second opened state (third state) in the opposite direction (direction X2) to the first direction X1, and is displaced by a third distance in a direction that is opposite (direction Y2) to the second direction Y1 as described below.

As illustrated in FIG. 2 and FIG. 3C, in the second opened state (third state), the display unit side casing 3 slides so that the operating unit 10 and the display unit 21 are disposed on substantially the same plane. In the second opened state (third state), the display unit side casing 3 is displaced by a second distance from the position in the first opened state (second state) in the first direction X1, and is displaced by a third distance in the second direction Y1 that is perpendicular to the operating unit side surface 2a so that the display unit side surface 3a is positioned substantially on the same plane as the operating unit side surface 2a.

The portable telephone 1 is configured so that the thicknesses in the longitudinal direction (first direction X1, direction X2) in the second opened state are substantially the same. More specifically, the first portion 3A, the third portion 2A, and the stacked portion 90 in which the second portion 3B and the fourth portion 3B are stacked each other are aligned in the first direction X1 and configured to have substantially the same thickness.

When the portable telephone 1 is in the second opened state, the first inclining surface 101 and the second inclining surface 102 are substantially parallel, and are disposed to be mutually opposed in the first direction X1. The first inclining surface 101 and the second inclining surface 102 are disposed in a proximate and opposed configuration.

When the portable telephone 1 is in the second opened state, the fourth inclining surface 104 and the fifth inclining surface 105 are substantially parallel, and are disposed to be mutually opposed in the first direction X1. The fourth inclining surface 104 and the fifth inclining surface 105 are disposed in a proximate and opposed configuration.

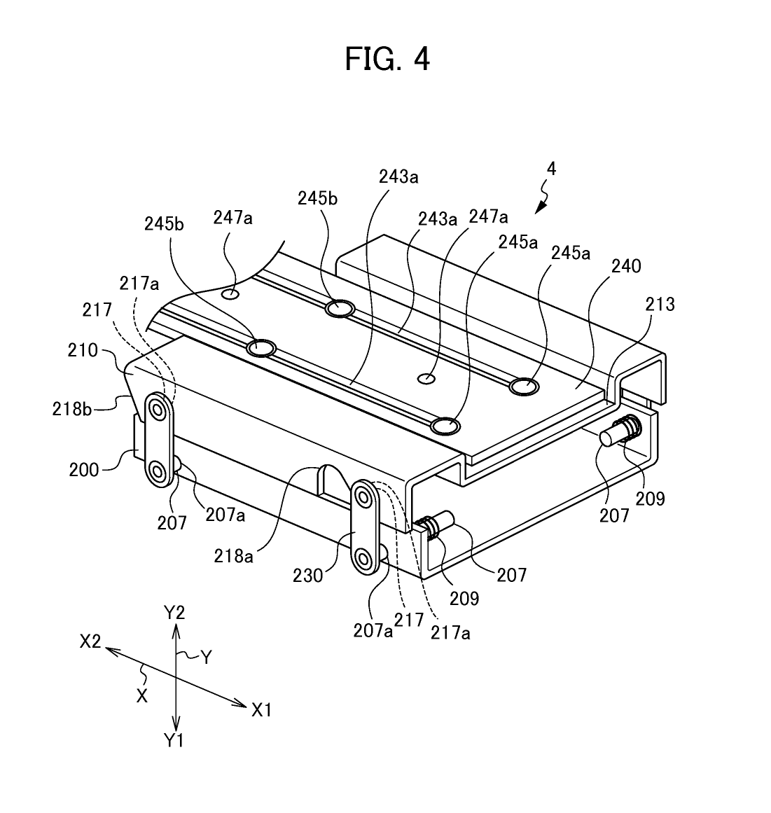

Next, the connecting member 4 will be described making reference to FIG. 4 to FIG. 10.

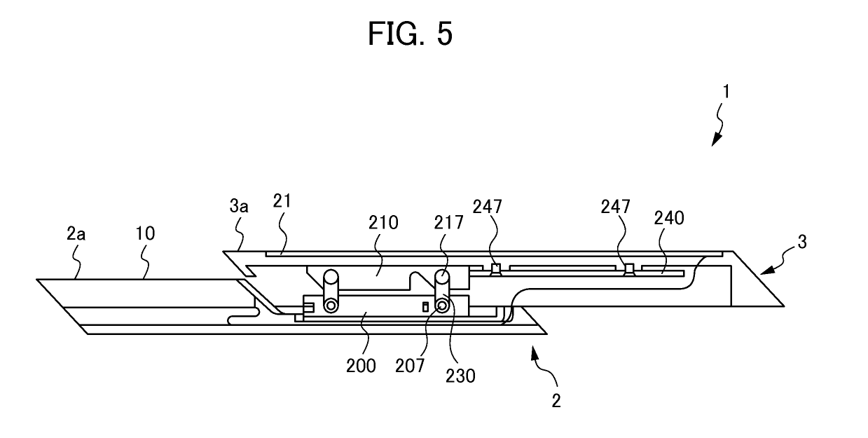

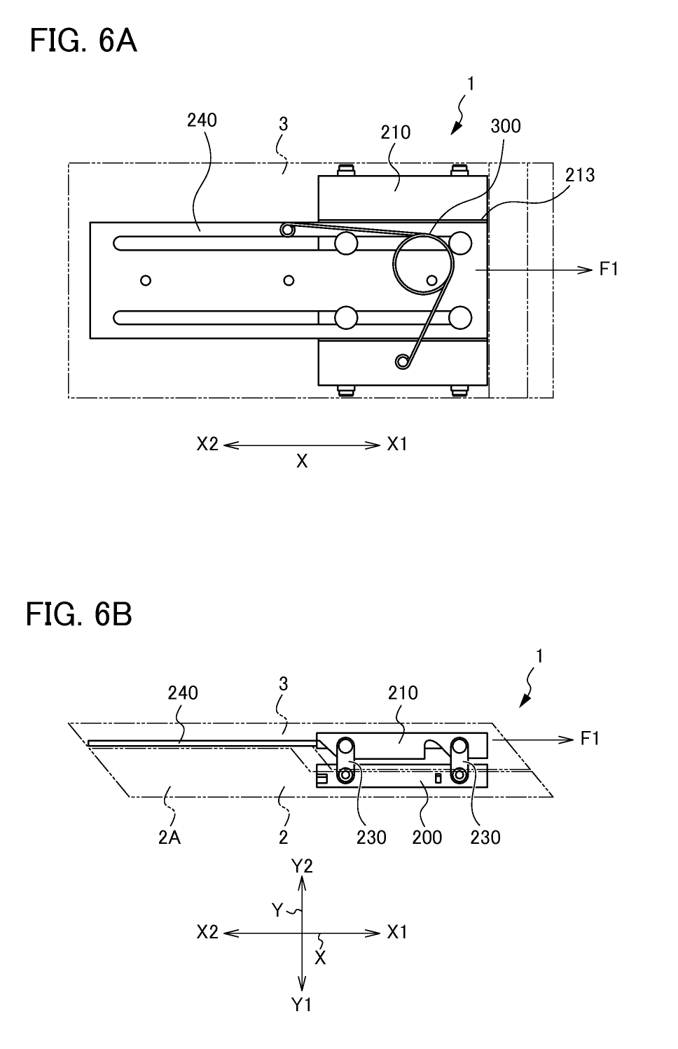

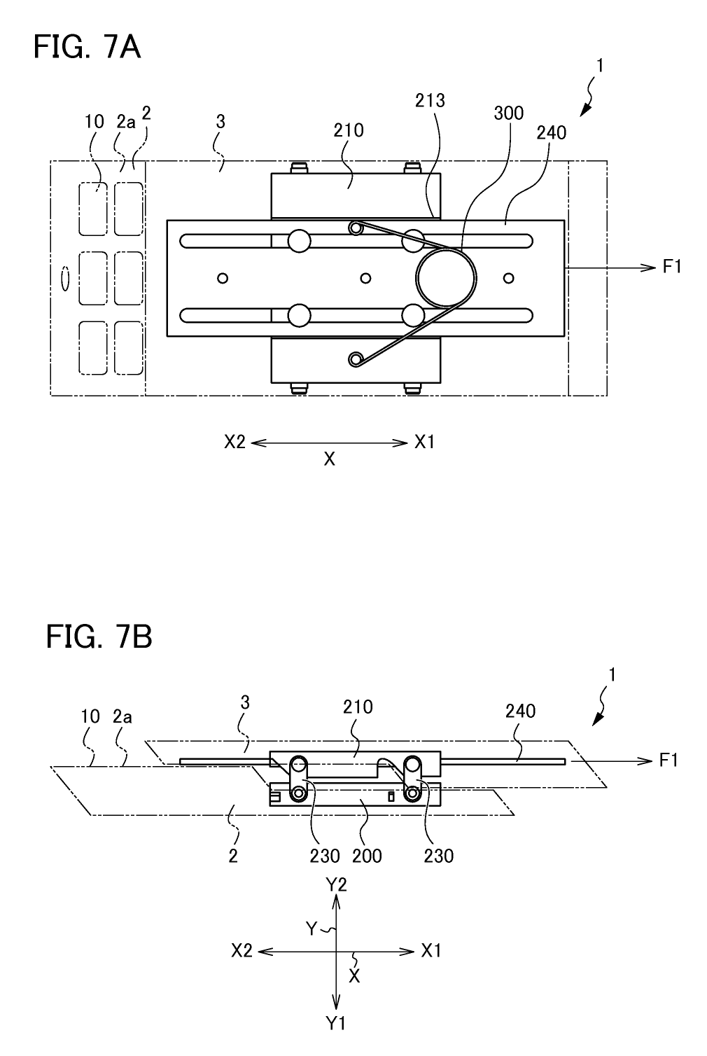

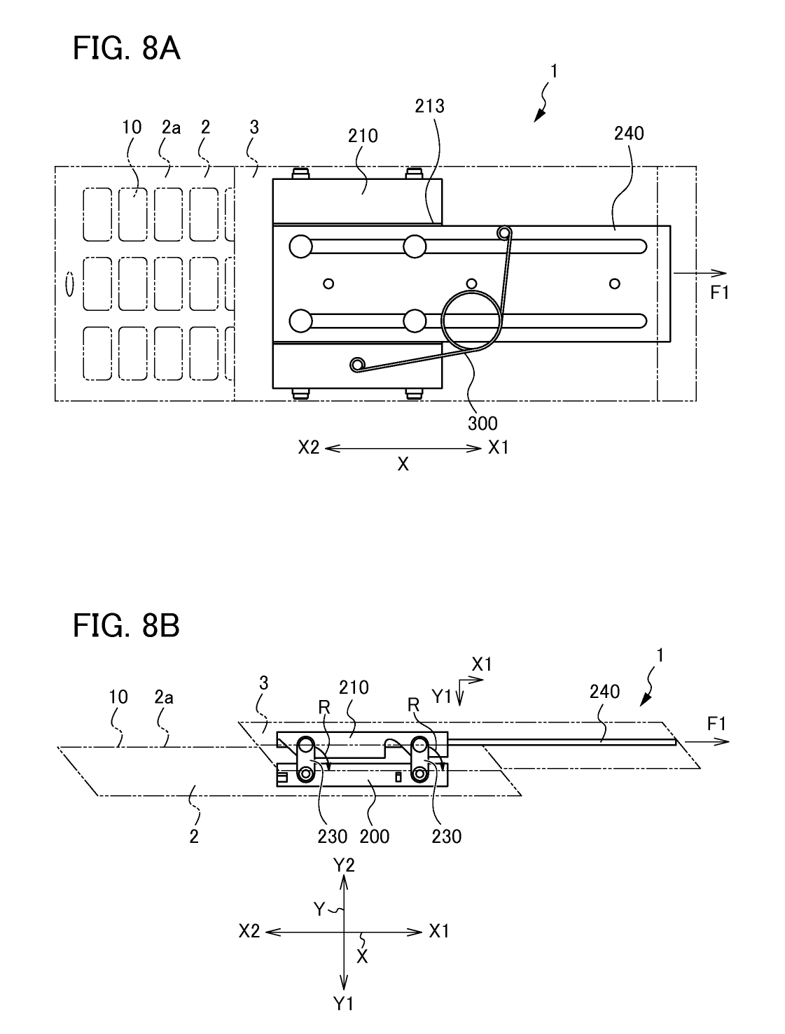

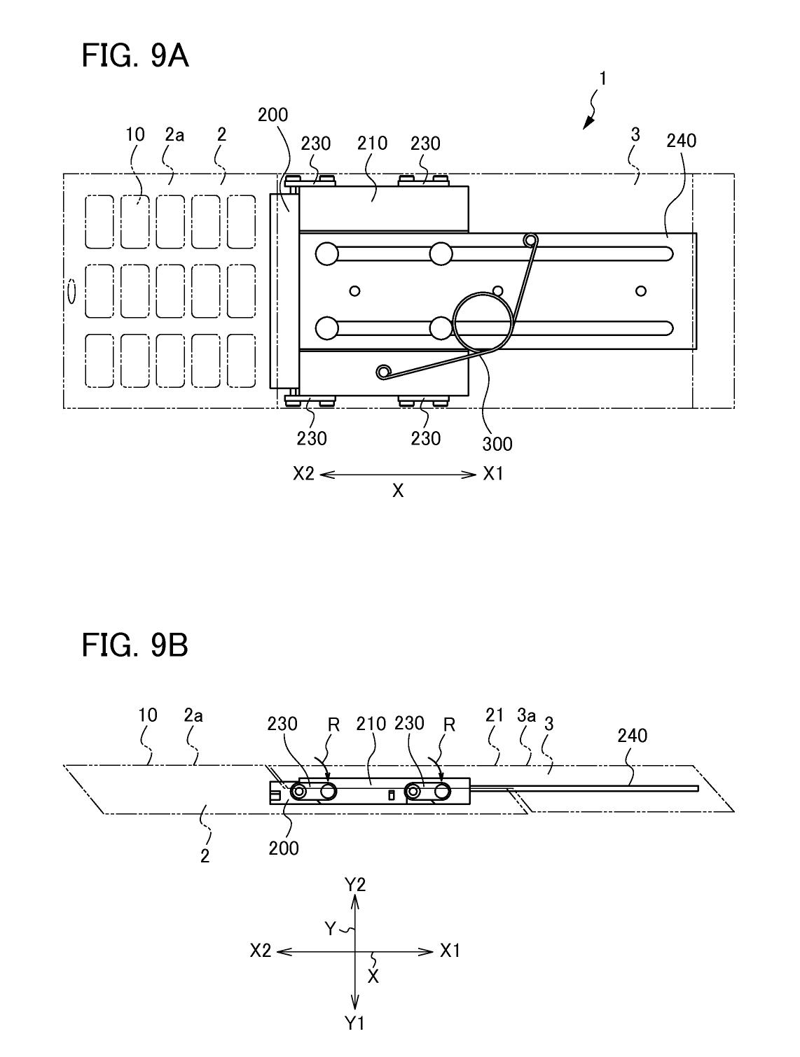

FIG. 4 is a perspective view describing a configuration of the connecting member 4. FIG. 5 is a side view describing the disposition of each member on the connecting member 4. FIG. 6A is a plan view describing a configuration of the connecting member 4 in the closed state (first state). FIG. 6B is a side view describing a configuration of the connecting member 4 in the closed state (first state). FIG. 7A is a plan view describing a configuration of the connecting member 4 in a state between the closed state (first state) and the first opened state (second state). FIG. 7B is a side view describing a configuration of the connecting member 4 in a state between the closed state (first state) and the first opened state (second state). FIG. 8A is a plan view describing a configuration of the connecting member 4 in the first opened state (second state). FIG. 8B is a side view describing a configuration of the connecting member 4 in the first opened state (second state). FIG. 9A is a plan view describing a configuration of the connecting member 4 in the second opened state (third state). FIG. 9B is a side view describing a configuration of the connecting member 4 in the second opened state (third state). FIG. 10 is a schematic view describing a first inclining surface 101.

The connecting member 4 connects the operating unit side casing 3 and the display unit side casing 3 so that the portable telephone 1 can be switched between the closed state (first state), the first opened state (second state) and the second opened state (third state).

As illustrated in FIG. 4 and FIG. 5, the connecting member 4 includes a first member 200, a second member 210 that is disposed the first casing side on the first member 200 and that includes a guide portion 213 that is formed on the opposite side to the first member 200, a linking portion 230 that is rotatably connected respectively to the first member 200 and the second member 210 and that connects the first member 200 and the second member 210, and a rail member 240 that acts as a guided member that is guided by the guide portion 213 in the first direction X1 (direction X2).

The first member 200 is a box-shaped member that is fixed to the operating unit side casing 3. The linking portions 230, 230, 230, 230 are rotatably mounted on the first member 200.

As illustrated in FIG. 4, the second member 210 is disposed on the first member 200 of the display unit side casing 3 side, and as illustrated in FIG. 4 is a box-shaped member including a centrally-disposed transverse indentation on an upper surface. A first notch 218a and a second notch 218b are formed on a side wall on the second member 210. The first notch 218a and the second notch 218b are formed at a position corresponding to pivot members 207, 207 in a state in which the portable telephone 1 is in the second opened state and the second member 210 is aligned in the first direction X1 with the first member 200. The first notch 218a and the second notch 218b are portions that are formed by cutting the side wall to avoid contact with the pivot members 207, 207 in a state in which the second member 210 is aligned in the first direction X1 with the first member 200.

The second member 210 includes the guide portion 213 that is formed on the opposite side to the first member 200.

The guide portion 213 is an indentation formed on the second member 210 on the opposite side to the first member 200 and is formed to extend in the first direction X1 (direction X2).

The linking portion 230 is an elongated tabular member Two linking portions 230 are respectively disposed on both side surfaces on the connecting member 4. A cylindrical pivot member 207 and an pivot member 217 are respectively fixed to both ends of the linking portion 230.

The pivot member 207 and the pivot member 217 are respectively inserted into an insertion hole 207a formed on the first member 200 and an insertion hole 217a formed on the second member 210.

In this manner, the linking portion 230 is rotatably connected respectively to the display unit side casing 3 and the operating unit side casing 2. The linking portion 230 connects the display unit side casing 3 and the operating unit side casing 2.

More specifically, the linking portion 230 connects the first member 200 and the second member 210 so that when the portable telephone 1 is in the closed state and the first opened state, the second member 210 is stacked in the second direction Y1 (direction Y3) with the first member 200, and when the portable telephone 1 is in the second opened state, the second member 210 is aligned in the first direction X1 (direction X2) with the first member 200.

In this context, the linking portion 230 can rotate at a first position that is disposed to extend in a direction that is parallel to the direction of thickness (perpendicular to the operating unit side surface 2a) and a second position that is disposed to extend in a direction that is parallel to longitudinal direction (parallel to the operating unit side surface 2a).

In other words, the rotation angle in the linking portion 230 is substantially 90 degrees.

In this manner, the display unit side casing 3 can be suppressed from separating from the operating unit side casing 2 by rising in the thickness direction (second direction Y1, direction Y2) when the display unit side casing 3 displaces in the first direction X1.

The linking portion 230 is biased to rotate from the first position to the second position by a coil spring 209 that is disposed along an outer periphery of the pivot member 207. The linking portion 230 is biased by a coil spring 209 to be switched from a state in which the second member 210 faces the first member 200 to a state in which the second member 210 is aligned with the first member 200 in the first direction X1.

The rail member 240 is a tabular member that includes two grooves 243a, 243a that extend in a longitudinal direction. The rail member 240 is fixed to an inner surface on the display unit side casing 3.

The rail member 240 is fixed to an inner surface on the display unit side casing 3 by a threaded member 247 that is inserted into a hole 247a formed in the rail member 240.

The rail member 240 is disposed to slide on the indented guide portion 213. The rail member 240 is guided and slides in the first direction X1 (direction X2) by the guide portion 213.

The direction of displacement of the rail member 240 is limited to the first direction X1 (direction X2) by regulating members 245a, 245a, 245b, 245b that are respectively inserted into two grooves 243a, 243a and the two grooves 243a, 243a formed on the rail member 240. Furthermore, the position of displacement of the rail member 240 is limited to the first direction X1 (direction X2) by regulating members 245a, 245a, 245b, 245b that are respectively inserted into two grooves 243a, 243a and the two grooves 243a, 243a formed on the rail member 240.

More specifically, the position to which the rail member 240 can displace in the first direction X1 is limited by the end of the grooves 243a, 243a and the regulating members 245b, 245b.

When the rail member 240 displaces to a position in relation to which displacement is limited in the first direction X1, if a force causing further displacement in the first direction X1 acts on the rail member 240, a force is transmitted to the second member 210 through the rail member 240, and the second member 210 is displaced in the first direction X1. In this manner, the linking portion 230 is rotated, and the second member 210 is displaced by a predetermined distance in the first direction X1 (second distance) and by a predetermined distance (third distance, a distance that is the same as the second distance in the present embodiment) in the second direction Y1. That is to say, the portable telephone 1 can be switched from the first opened state to the second opened state.

Furthermore, the position to which the rail member 240 can displace in the direction X2 is limited by the end of the grooves 243a, 243a (end on the opposite side to the end above) and the regulating members 245a, 245a.

When the rail member 240 displaces to a position in relation to which displacement is limited in the direction X2, if a force causing further displacement in the direction X2 acts on the rail member 240, a force is transmitted to the second member 210 through the rail member 240, and the second member 210 is displaced in the direction X2. In this manner, the linking portion 230 is rotated (rotated in the opposite direction to the above rotation), and the second member 210 is displaced by a predetermined distance in the direction X2 (fourth distance) and by a predetermined distance in the direction Y2 (fifth distance, a distance that is the same as the fourth distance in the present embodiment). That is to say, the portable telephone 1 can be switched from the second opened state to the first opened state.

As described above, the grooves 243a and 243a and the regulating members 245a, 245a, 245b, 245b configure a displacement regulating member that restricts the displacement position of the rail member 240.

Herein, a biasing member 300 may be mounted in relation to the connecting member 4. More specifically, the biasing member 300 may be mounted on the connecting member 4 so that when the display unit side casing 3 displaces in the first direction X1, the display unit side casing 3 is biased in the direction X2 to the predetermined position, and so that, after passing through the predetermined position, the display unit side casing 3 is biased in the first direction X1.

More specifically, when the rail member 240 slides in the first direction X1, the biasing member 300 biases the rail member 240 in the direction X2 up to the predetermined position (for example, the position at FIG. 7A), and biases the rail member 240 in the first direction X2 after passing the predetermined position. Conversely, when the rail member 240 slides in the direction X2, the biasing member 300 biases the rail member 240 in the first direction X1 up to the predetermined position and biases the rail member 240 in the direction X2 after passing the predetermined position.

The biasing member 300 is a resilient member forming a coil portion by winding an intermediate portion onto metallic wire member, and may be configured as a resilient member that produces a widening bias that tends to separate one end from the other end. One end of this type of biasing member 300 is fixed to a predetermined position on the rail member 240, and the other end is fixed to a predetermined position on the second member 210 to thereby enable the function as described above (reference is made to FIG. 6A, FIG. 7A and FIG. 8A).

Next, the operation of the connecting member 4 will be described making reference to FIG. 6A to FIG. 9B.

As illustrated in FIG. 6A and FIG. 6B, the second member 210 in the closed state (first state) is disposed to overlap in the thickness direction with the first member 200 (second direction Y1, direction Y2).

In the opened state, the rail member 240 is disposed at a position at which displacement is restricted in relation to the direction X2.

In the closed state, a part of the rail member 240 is disposed on the guide portion 213 in the second member 210, and almost all the portion of the other part is disposed to overlap in the thickness direction (second direction Y1, direction Y2) with the third portion 2A on the operating unit side casing 2.

Furthermore, when the portable telephone 1 is in the closed state, the biasing member 300 biases the rail member 240 in the direction X2.

In this context, when a user applies a force F in the direction of the arrow onto the display unit side casing 3, the rail member 240 slides in the first direction X1.

As stated above, since a biasing force is applied to the rail member 240 in the direction X2 by the biasing member 300, when a user removes their hand, the rail member 240 (display unit side casing 3) returns from the displaced position to an original position (position in the closed state).

In FIG. 7A and FIG. 7B, during the switch of the portable telephone 1 from the closed state to the first opened state (change of state), when the rail member 240 displaces to the predetermined position, the biasing member 300 no longer applies a biasing force in the direction X2 by. When the rail member 240 passes through the predetermined position by further displacement in the first direction X1, the biasing member 300 biases the rail member 240 in the first direction X1. That is to say, since the biasing member 300 applies a biasing force to the rail member 240 in the first direction X1, when a user removes their hand, the rail member 240 (display unit side casing 3) is biased to a position in the first opened state.

When more towards a position in the closed state than the predetermined position, the rail member 240 is biased by the biasing member 300 in a direction of return to the position in the closed state (direction X2), and when in a position more towards the first opened state than the predetermined position, it is biased by the biasing member 300 in a direction towards a position in the first opened state (first direction X1).

As illustrated in FIG. 8A and FIG. 8B, when the rail member 240 is displaced further in the first direction X1 from the position in the state as described above, the portable telephone 1 is switched (change of state) to the first opened state (second state).

When the portable telephone 1 is in the first opened state (second state), the second member 210 is disposed to be stacked with the first member 200 in the direction of thickness (second direction Y1, direction Y2).

When the portable telephone 1 is in the first opened state (second state), the rail member 240 is disposed at a position at which displacement is restricted in relation to the first direction X1.

When the portable telephone 1 is in the first opened state (second state), a portion of the rail member 240 is disposed on the guide portion 213 in the second member 210, and almost the whole of the other part is disposed not to overlap in the thickness direction with the operating unit side casing 2. The rail member 240 is disposed so that the end on the opposite side to the end used for disposition in the closed position is disposed on the guide portion 213.

Furthermore, in the first opened state, the biasing member 300 biases the rail member 240 in the first direction X1.

When the portable telephone 1 is in the first opened state, if a force F1 is applied in the direction of the arrow to the display unit side casing 3, the force F1 is transmitted to the second member 210 through the rail member 240 that is subjected to a restriction in displacement in the first direction X1.

In this manner, the linking portion 230, 230 can rotate and displace in the direction of the arrow R. That is to say, the second member 210 displaces by a predetermined distance (second distance) in the first direction X1, and displaces by a predetermined distance (third distance) in the second direction Y1.

As illustrated in FIG. 9A and FIG. 9B, when the linking portion 230, 230 rotates and displaces from a position in the first opened state (second state), the portable telephone 1 is switched (change of state) to the second opened state (third state).

When the portable telephone 1 is in the second opened state (third state), the second member 210 is aligned in the first direction X1 with the first member 200.

In the above embodiment, the angle a subtended by first inclining surface 101 and the operating unit side surface 2a as illustrated in FIG. 10 is 135 degrees. However, the angle a is not limited to 135 degrees. The angle a may be an arbitrary angle of less than or equal to 135 degrees.

In the present embodiment, the first inclining surface 101 is planar. However, the invention is not limited in this respect and it may be curved or have a shape that includes an indentation on the surface. The first inclining surface 101 does not include a portion that projects over a curved line G2 that is parallel to the orbit G1 of the pivot member 217 disposed the display unit side casing 3 side on the inclining surface 203.

As described above, the portable telephone 1 enables continuous switch (change of state) from the closed state (first state) to the second opened state (third state) by displacing the display unit side casing 3 in the closed state (first state) in the first direction X1. However, it is obvious that continuous displacement (change of state) is enabled from the second opened state (third state) to the closed state (first state) by displacing the display unit side casing 3 in the second opened state (third state) in the direction X2.

According to the present embodiment, a portable telephone 1 can be provided in which, in the closed state, the display unit side casing 3 and the operating unit side casing 2 are mutually stacked with respect to the thickness direction, and in the second opened state, the display unit side casing 3 and the operating unit side casing 2 are mutually aligned in the first direction X1.

That is to say, according to the present embodiment, the portable telephone 1 can be provided in which, in the closed state, both casings are in a stacked state, and in the second opened state, both casings are changed in a straight configuration aligned in a planar direction.

According to the present embodiment, the portable telephone 1 can be configured to include a high thickness portion and a low thickness portion respectively in the operating unit side casing 2 and the display unit side casing 3. Therefore, when both casings are changed (change of state) in a straight configuration in which both casings are aligned in the planar direction, the thickness is substantially uniform.

According to the present embodiment, the portable telephone 1 disposes the operating unit side surface 2a of the operating unit side casing 2 and display unit side surface 3a of the display unit side casing 3 on substantially the same plane in the second opened state. Therefore, operability for a user is improved. More specifically, the portable telephone 1 disposes the operating unit 10 and the display unit 21 on substantially the same plane in the second opened state, and there is no step between the operating unit side casing 2 and the display unit side casing 3. Therefore, operability for a user is improved.

According to the present embodiment, the rotation angle of the linking portion 230 in the connecting member 4 is substantially 90 degrees. As a result, when the portion of the display unit side casing 3 that is stacked on one side of the operating unit side casing 2 is displaced to a position which is aligned with the operating unit side casing 2 in the planar direction, the operating unit side casing 2 is displaced to a predetermined position without separation from the operating unit side casing 2 resulting from lifting up with respect to the thickness direction.

In this manner, when the portable telephone 1 is switched from the closed state to the second opened state, the finger or the like of a user is suppressed from becoming jammed between the first casing and the second casing, and in addition, particulate matter and foreign objects are suppressed from entering from the outside to the inside between the first casing and the second casing.

According to the present embodiment, the portable telephone 1 is configured to include the connecting member 4 including the rail member 240 that slides the display unit side casing 3 and a linking portion 230 that rotates the display unit side casing 3. In this manner, the display unit side casing 3 can displace through a large distance in the first direction X1 without requiring a user to lift up and separating from the display unit side casing 2 during displacement.

According to the present embodiment, when the portable telephone 1 is in the second opened state, the first inclining surface 101 and the second inclining surface 102 are disposed in proximity. When the portable telephone 1 is in the second opened state, the fourth inclining surface 104 and the fifth inclining surface 105 are disposed to face each other. In this manner, even when the portable telephone 1 is switched (change of state) from the closed state to the second opened state, particulate matter or foreign objects are suppressed from entering from the outside to the inside.

According to the present embodiment, the portable telephone 1 can be provided with a characteristic design.

According to the present embodiment, since the rail member 240 is biased by the biasing member 300, the portable telephone 1 is suppressed from a configuration in which the display unit side casing 3 is disposed at a mid-end position during the switch (change of state) of the portable telephone 1 from the first opened state to the second opened state. According to the present embodiment, a portable telephone 1 can be provided that is suppressed from being fixed in a difficult to use configuration.

Although the preferred embodiments have been described above, the present invention is not limited thereby and can be executed in various configurations. For example, in the present embodiment, although the portable telephone 1 was described as an example of a mobile electronic device, the present invention is not limited thereby and may be applied to a personal handy phone system (Registered Trademark) (PHS), a personal digital assistant (PDA), a portable navigation device, a notebook computer, or the like.

In the present embodiment, the first casing is the display unit side casing 3 that includes the display unit side surface on which a display unit 21 is disposed, and the second casing 2 is the operating unit side casing 2 that has an operating unit side surface 2a on which the operating unit 10 is disposed. However, the present invention is not limited thereby and the opposite configuration may be adopted.

1. An electronic device comprising
a first casing that has a first surface disposing at least one of a display unit or an operating unit,
a second casing that has a second surface disposing at least one of a display unit or an operating unit, and
a connecting member configured to connect the first casing and the second casing,
wherein the connecting member connects the first casing and the second casing to enable a switch between a first state in which the first casing is stacked on the second surface of the second casing, the first surface is exposed to the outside in a substantially parallel positional relationship to the second surface, and the whole or a portion of the second surface is covered by the first casing,
a second state in which the first casing is displaced by a first distance from a position in the first state in a first direction that is parallel to the second surface, and
a third state in which the first casing is displaced by a second distance in the first direction from a position in the second state, and is displaced by a third distance in the second direction that is perpendicular to the second surface so that the first surface is positioned on substantially the same plane as the second surface.

2. The electronic device according to claim 1,
wherein the first casing includes
a first portion, and
a second portion that has a lower thickness than the first portion, and
the second casing includes
a third portion that has a second surface, and
a fourth portion that has a lower thickness than the third portion, and is stacked in the second direction with the second portion in the third state, and
in the third state,
the first portion, the third portion, the stacked portion in which the second portion and the fourth portion are stacked each other are aligned in the first direction and configured to have substantially the same thickness.

3. The electronic device according to claim 2,
wherein the third portion of the second casing includes
a first inclining surface formed on the first casing side and the fourth portion side, and
the second portion of the first casing includes
a second inclining surface formed directed to the second casing on the end on the opposite side to the first portion, and wherein
the first inclining surface and the second inclining surface are mutually substantially parallel in the third state, and are mutually opposed in the first direction.

4. The electronic device according to claim 3,
wherein the third portion of the second casing includes
a third inclining surface formed directed to the opposite side to the first casing on the end opposite to the fourth portion, and
in the first state, the third inclining surface is substantially parallel to the first inclining surface, and disposed on substantially the same plane as the second inclining surface.

5. The electronic device according to claim 3,
wherein the first portion of the first casing includes
a fourth inclining surface formed on the second casing side and the second portion side, and
the fourth portion of the second casing includes
a fifth inclining surface formed directed to the first casing on the end on the opposite side to the third portion, and
wherein the fourth inclining surface and the fifth inclining surface are substantially parallel in the third state, and are mutually opposed in the first direction.

6. The electronic device according to claim 5,
wherein the first portion of the first casing includes
a sixth inclining surface formed directed to the opposite side to the second casing on the end on the opposite to the second portion, and in the first state, the sixth inclining surface is substantially parallel to the first inclining surface, and disposed on substantially the same plane as the fifth inclining surface.

7. The electronic device according to claim 1, further comprising a biasing member, wherein when the first casing displaces in the first direction,
the biasing member bias the first casing in the opposite direction to the first direction up to a predetermined position ,and bias the first casing in the first direction after passing through the predetermined position.

8. The electronic device according to claim 1,
wherein the connecting member includes a guided member that is fixed to an inner portion of the first casing,
a first member that is fixed to an inner portion of the second casing,
a second member that is disposed on the first casing side in the first member and that includes a guide portion that is formed on the opposite side to the first member and is configured to guide the guided member in a first direction,
a displacement restriction portion that restricts the displacement position of the guided member, and
a linking portion that is rotatably connected respectively to the first member and the second member and that connects the first member and the second member, and
wherein the linking portion connects the first member and the second member so that the second member is stacked with the first member in the second direction in the first state and the second state, and that the second member is aligned with the first member in the first direction in the third state.

9. An electronic device comprising
a first casing that has a first surface disposing at least one of a display unit or an operating unit,
a second casing that has a second surface disposing at least one of a display unit or an operating unit, and
a connecting member configured to connect the first casing and the second casing,
wherein the connecting member includes
a guided member that is fixed to an inner portion of the first casing,
a first member that is fixed to an inner portion of the second casing,
a second member that is disposed on the first casing side in the first member and that includes a guide portion that is formed on the opposite side to the first member and is configured to guide the guided member in a first direction that is a parallel direction to the second surface,
a displacement restriction portion that restricts the displacement position of the guided member, and
a linking portion that is rotatably connected respectively to the first member and the second member and that connects the first member and the second member, and
wherein the linking portion connects the first member and the second member in a mutual configuration that can be switched between a state in which the second member is stacked in a second direction that is perpendicular to the second surface with respect to the first member and a state in which the second member is aligned with the first member in the first direction.

10. A connecting member comprising
a guided member that is fixed to an inner portion of the first casing,
a first member that is fixed to an inner portion of the second casing,
a second member that is disposed the first casing side on the first member and that includes a guide portion that is formed on the opposite side to the first member and is configured to guide the guided member in a first direction,
a displacement restriction portion that restricts the displacement position of the guided member, and
a linking portion that is rotatably connected respectively to the first member and the second member and that connects the first member and the second member,
wherein the linking portion connects the first member and the second member in a mutual configuration that can be switched between a state in which the second member is stacked in a second direction that is perpendicular to the first direction with respect to the first member and a state in which the second member is aligned with the first member in the first direction.
